(19) United States
(12) Patent Application Publication
(10) Pub. No.: US 2004/0076309 A1
(43) Pub. Date: Apr. 22, 2004

(54) Audio radiator with radiator flexure minimization and voice coil elastic anti-wobble members

(76) Inventor: Joseph Y. Sahyoun, Redwood City, CA (US)

Correspondence Address: Allston L. Jones, PETERS, VERNY, JONES & SCHMITT, L.L.P., Suite 6, 385 Sherman Avenue, Palo Alto, CA, 94306-1840, US

(21) Appl. No.: 10/646,548

(22) Filed: Aug. 21, 2003

Related U.S. Application Data
(60) Provisional application No. 60/405,416, filed on Aug. 21, 2002.

(51) Int. Cl. H04R 1/00; H04R 9/06; H04R 11/02

(52) U.S. Cl. 381/412; 381/420; 381/404; 381/405

(57) ABSTRACT

A speaker having a generally linear response by configuring two elastic members opposite one another so that any non-linearlity in the spring constant between an outward displacement versus an inward displacement are substantially cancelled. The present invention provides a pseudo linear spring constant throughout the range of travel of the cone and voice coil, or the sound baffle for a passive radiator. This minimizes the flexing of the cone and the wobble of the voice coil tube, or the baffle, as each travels to reproduce the audio waves.

### CROSS REFERENCE

This application claims priority from U.S. provision application having serial No. 60/405,416 filed Aug. 21, 2003.

### BACKGROUND OF THE INVENTION

1. Field of the Invention

This invention relates to passive radiators and loud speakers, in particular to the construction of same with minimization of flexure of the radiator and wobble minimization of the voice coil throughout the full range of inner and outer travel of the radiator during operation.

2. Description of the Related Art

In an audio speaker, or transducer, the closer together the points on the speaker frame, or basket, to which the suspension and spider are connected the greater the possibility of rocking, or wobble of the voice coil tube, or bobbin, with respect to the magnet during operation of the speaker. In a conventional speaker, the suspension is attached between the mouth of the basket and the outer diameter of the cone with the spider deeper in the basket beneath the surround. Wobble of the voice coil results from flexing of the speaker cone during operation as opposed to an even push or pull being exercised by the voice coil around the circumference where it connects to the speaker cone. When the cone is flexed, the upper end of the voice coil tube where it attaches to the cone and the lower end of that tube surrounding the magnet are no longer directly above each other with respect the central axis of the speaker. Stated another way, when wobble occurs the central axis of the voice coil tube momentarily is not coincident with the central axis of the speaker, i.e., the central axis of the voice coil tube is not parallel to the central axis of speaker. Thus, when the cone flexes and the voice coil wobbles, unwanted distortions occur in the sound waves being reproduced by the speaker. Such distortion effects are often audible to the listener. Since the human hear does not have a flat response to all frequencies, the audio frequency where the mechanical distortion occurs and the percentage of distortion created determines whether or not the distortion created is audible to the listener.

In U.S. Pat. No. 5,323,469, Scholz proposed the addition of a substantially conical stabilizing element between the underside of the speaker cone and the tube on which the voice coil is wound. In the Scholz configuration, the center of the cone is attached to the upper end of the voice coil tube and the conical stabilizing element is attached to the voice coil tube about one third the length of that tube below the connection point of the tube with the speaker cone. Additionally, a conventional spider is connected between the speaker frame and the voice coil tube at the point where the conical stabilizing element attaches to the voice coil tube. While this may present some improvement in the distortion level, the forces on the cone and voice coil presented by the spider remains uneven and can still produce flexing of the speaker cone resulting in differing degrees of distortion through out the travel of the cone and voice coil.

### SUMMARY OF THE INVENTION

The present invention overcomes the drawbacks of the prior art by providing a generally linear response by configuring two elastic members opposite one another so that any non-linearlity in the spring constant between an outward displacement versus an inward displacement are substantially cancelled. The present invention provides a pseudo linear spring constant throughout the central range of travel of the cone and voice coil. This minimizes the flexing of the cone and the wobble of the voice coil tube.

### BRIEF DESCRIPTION OF THE DRAWINGS

FIGS. 1a-1c are each a profile slice of the center of a typical prior art speaker with the cone in either the maximum extended, the rest or the maximum retracted position, respectively;

FIGS. 2a-2c are each a profile slice of the center of a speaker of the basic structure shown in FIGS. 1a-1c for one embodiment of the present invention;

FIGS. 3a-3c are each a profile slice of the center of a speaker of the structure shown in FIGS. 2a-2c with the cone replaced with a flat baffle for a second embodiment of the present invention;

FIGS. 4a-4c are each a profile slice of the center of a speaker with a concave to cone for a third embodiment of the present invention; and

FIGS. 5a-5c are each a profile slice of the center of a speaker with a concave cone having an open center hole with a center pillar of the magnet extending upward through that hole for a fourth embodiment of the present invention.

### DETAILED DESCRIPTION OF THE PRESENT INVENTION

The flexing of the cone, causing the cone to change shape, in different positions as the cone is driven is related directly to the composition of the cone material, with the dynamic characteristics of the cone material responsible for the flexing which can only be overcome by the selection of a different material for the cone. However, if the flexing of the cone is caused by the geometry of the overall speaker design, the flexing of the cone can be overcome by configuring the cone, flexible surround and resilient spider of the speaker such that the resultant force(s) that cause the unwanted flexing of the cone are cancelled at points on the cone where the spider and/or the surround attach to the cone (i.e., the forces are balanced before they cause flexure of the cone) for all positions through which the cone is driven.

In speaker design, when the voice coil is at rest the shape of the cone is considered the reference shape that is determined by the static forces and weight of the various components of the speaker, including the surround and spider. To minimize distortion of the cone and wobble of the voice coil, the at rest shape is the desired shape regardless of the position of the cone. However, conventional speakers do not balance the forces for all positions that the cone goes through as it travels. Not only does the flexing of the cone and wobble of the voice coil cause distortion in the sound reproduction of the speaker, it will, in time, cause failure of the cone as a result of the life cycle of the cone material from the varying stresses.

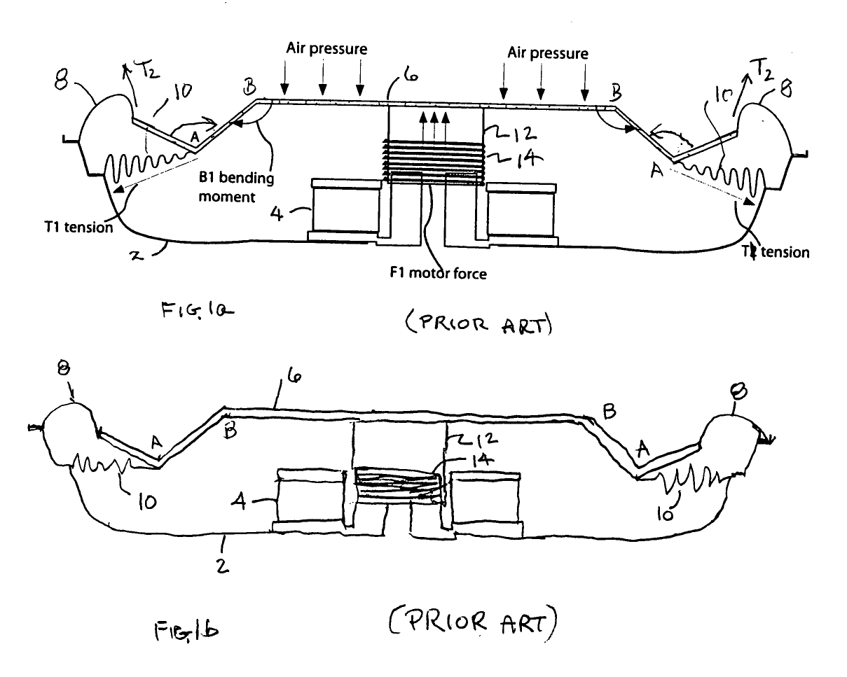

FIGS. 1a-1c are each a profile slice of the center of a typical prior art speaker (shown here as a low profile speaker) with the cone in the maximum extended, the rest and the maximum retracted position, respectively. In each of these figures the speaker includes basket 2, magnet assembly 4, cone 6, surround 8, spider 10, voice coil tube 12 and voice coil 14. In FIG. 1b the speaker is unenergized with the rest position of the cone 6 and voice coil 14 being determined by the weight and static elasticity of cone 6, surround 8, spider 10 and voice coil tube 12 since no electrical sign is applied to voice coil 14.

When cone 6 is in any position other than the at rest position of FIG. 1b, the forces presented by surround 8 and spider 10 and the resilience, or lack there of, of cone 6 come into play to balance out the vertical motor force Fl. As can be seen from FIGS. 1a and 1b, the tensile forces presented by spider 10 (T1) and surround 8 (T2) are not parallel to motor force Fl, therefore there is both vertical and horizontal components of each of those forces with only the vertical components balancing motor force Fl.

In FIG. 1a, for the speaker design of the example shown there, when cone 6 is at the maximum outward displacement, the tensile force T1 of the spider has a downward vertical component and an outward horizontal component with the horizontal component being substantially greater than the vertical component. Additionally, the horizontal component of T1 on one side of the speaker is balance by the horizontal component of T1 on the other side of the speaker. Thus, since T1 is not parallel to the segment of cone 6 between points A and B a bending moment will be created at point B. Since the horizontal component of T1 is greatest, the bending moment B1 at point B of cone 6 increases the included angle at point B. Similarly, the tensile force T2 of surround 10 presents an upward vertical component and an outward horizontal component with T2 not being parallel to the segment of cone 6 between point A and the point of attachment of surround 8 with the vertical component being much greater than the horizontal component. The vertical force component of T2 being greater causes a bending moment at point A of cone 6 that reduces the included angle at point A. The extent to which the angles at points A and B change is also dependent on the tensile strength and flexibility of cone 6. The changing of these angles can also cause distortion of the surface of cone 6 at points other than A and B which cause voice coil tube 12 to be displaced relative to the central axis of basket 2 as described above.

In FIG. 1c, for the speaker design of the example shown there, when cone 6 is at the maximum inward displacement the tensile force T1 of the spider has an upward vertical component and an outward horizontal component with the horizontal component being substantially greater than the vertical component. Since the horizontal component of T1 is greatest, the bending moment at point B of cone 6 increases the included angle at point B. Similarly, the tensile force T2 of surround 10 presents an upward vertical component and an outward horizontal component. Whether or not the included angle at point A changes depends on whether force T2 is parallel to the segment of cone 6 between point A and the point of attachment of surround 8. If T2 is parallel to that segment, then the included angle at point A does not change. If T2 is not parallel to that segment of cone 6, the change in the included angle at point A depends on which of the horizontal and vertical components of force T2 is greatest. If the horizontal component of is greatest, the included angle at point A will increase; alternatively, if the vertical component is greatest, the included angle at point A will decrease. Any changes to the shape of cone 6 in the inward most position has a different effect on the distortion of cone 6 and thus on the position of voice coil tube 12 relative to the central axis of the speaker basket 2. This variation of the position of voice coil tube 12 for different positions of cone 6 is defined as the wobble of voice coil tube 12.

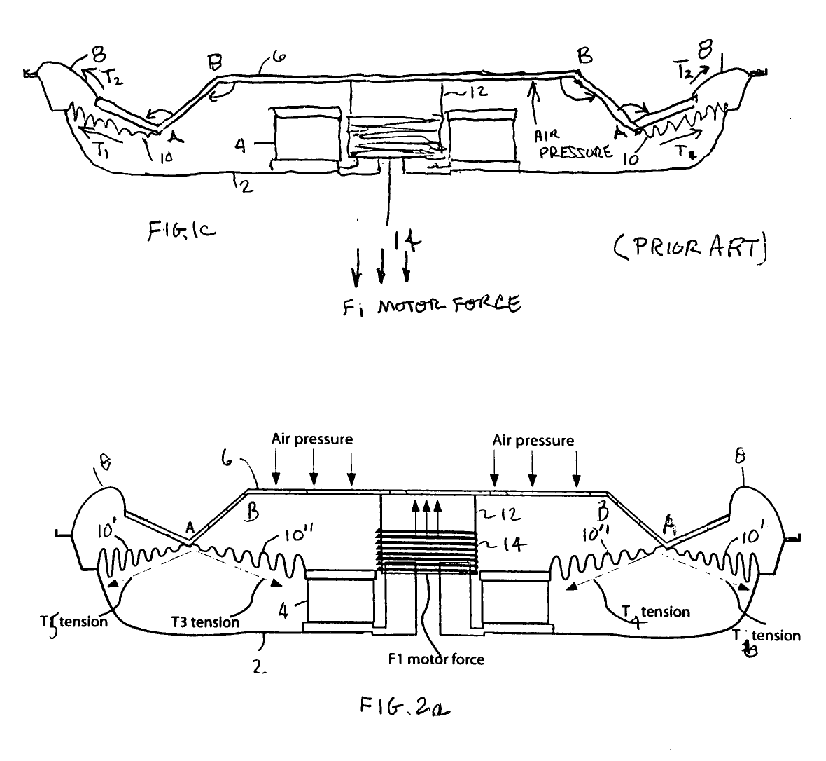

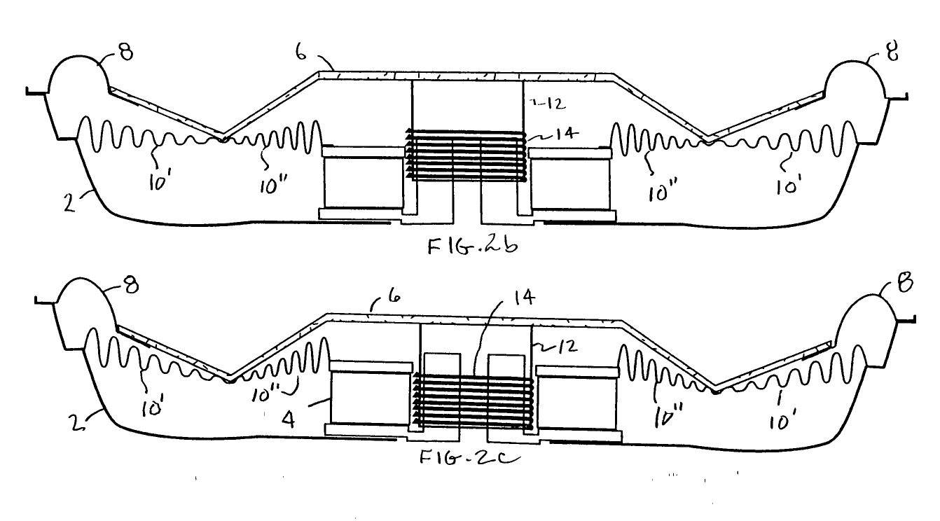

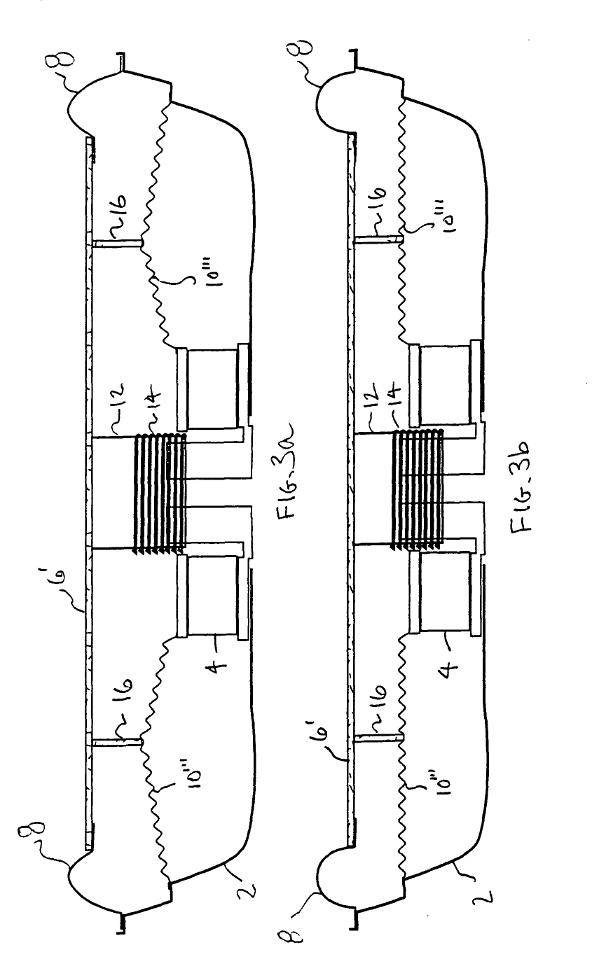

The present invention provides an speaker design wherein the forces on the cone are balanced at all times throughout the travel of the cone. For the first embodiment of the present invention, the basic structure of the speaker of FIGS. 1a-1c is modified. FIG. 2a shows cone 6 in the maximum outward position and since the basic structure here is the same as FIGS. 1a-1c, the same reference numbers are used. The differences in FIGS. 2a-2c with respect to FIGS. 1a-1c is the inclusion of an outer spider 10′ that is similar to spider 10 in FIGS. 1a-1c, and an inner spider 10″ between point A and the top of magnet 4. It can be seen that both spider 10′ and 10″ apply a tensile force to point A of cone 6 on both sides of the center slice of the speaker which is the same for any center slice taken trough the speaker.

In this configuration, on the left side outer spider 10′ applies force T5 on point A and inner spider 10″ applies force T3 on point A. Similarly on the right side of the speaker, outer spider 10′ applies force T6 on point A and inner spider 10″ applies force T4 on point A. Each of forces T3, T4, T5 and T6 have both a vertical and a horizontal component with spiders 10′ and 10″ being selected to balance the horizontal component of force on point A on both sides of the speaker in these view and totally around the speaker. That is, the horizontal outward component of T5 is equal to the inner horizontal component of T6, and the horizontal components of T2 and T4 are similarly balanced. By balancing the horizontal forces at point A on both sides of the speaker where the forces are applied, the result is no, or a very small bending moment at point B all around the speaker, unlike the prior art where the horizontal forces are balanced from the opposite side of the speaker (i.e., 180° around the speaker) as shown in FIGS. 1a-1c. While spiders 10′ and 10″ are discussed as being separate, they could be implemented as a single spider with point A of the cone affixed to a corresponding point on the spider where the forces balance, with point A being affixed to the spider continuously all the way around cone 6.

Since the material of surround 8 is much more flexible than the material used for spiders, the horizontal forces applied to the outer edge of cone 6 is much smaller than the horizontal forces applied by the stiffer spider at point A. This results in a minimal, or zero bending moment at point B while there may still be a small bending moment at point A resulting from the surround since the horizontal component of the tensile force applied by the surround is balance by a force applied on the other side of the speaker cone. Thus, the possibility of distortion of cone 6 and the resulting sound being reproduced is very small and most likely not above the threshold of the human ear.

It can be seen from FIGS. 2b and 2c, that the present invention provides a speaker design wherein the forces on the cone are substantially balanced at all times throughout the travel of the cone. As is the case with respect to FIG. 1b, in the configuration of FIG. 2b everything is at rest with the position of cone 6 is determined by the weight of cone 6 and voice coil tube 12, and the flexibility of surround 8 and spiders 10′ and 10″.

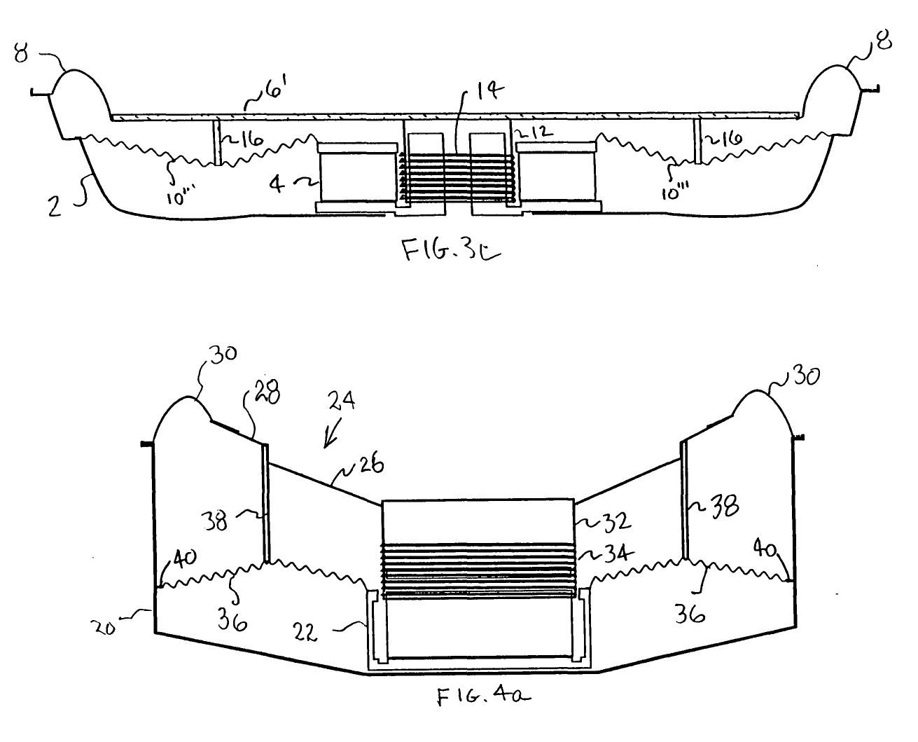

FIGS. 3a-3c show another shallow speaker design that is similar to that of FIGS. 2a-2c with cone 6 of FIGS. 2a-2c replaced with a flat cone or baffle 6′ formed with a ring 16 extending from the bottom side of baffle 6′ and having an internal diameter that is greater than the outside diameter of the largest components of magnet 4. Ring 16 can be attached to the underside of baffle 6′ in a number of different ways, including, but not limited to, being molded with baffle 6′ or fused or glued to baffle 6′. The lower extent of ring 16 then attaches to spider 10′″ at a point where substantially equal tension will be applied to ring 16 by each of the two portions of spider 10′″ (i.e., the portion between basket 2 and ring 16, and the portion between ring 16 and magnet 4). Of course, here, as in the previously described embodiment, spider 10′″ can be either one continuous spider or two individual spiders, one to each side of ring 16, and the bottom of ring 16 is equivalent to point A in FIGS. 2a-2c.

A passive radiator is like the speaker of FIGS. 3a-3c without the magnet and voice coil assembly, thus it can be seen that the same suspension technique lends itself to use in a passive radiator. While a passive radiator does not have a voice coil tube wobble problem, the entire baffle may wobble if the tension on ring 16 is unequal throughout the range of travel that it undergoes. That wobble could result in discernable distortion of the sound wave produced due to an uneven flexing of the baffle, and the side to side component of that wobble results in some energy being lost that could otherwise be delivered in the sound wave produced by the baffle.

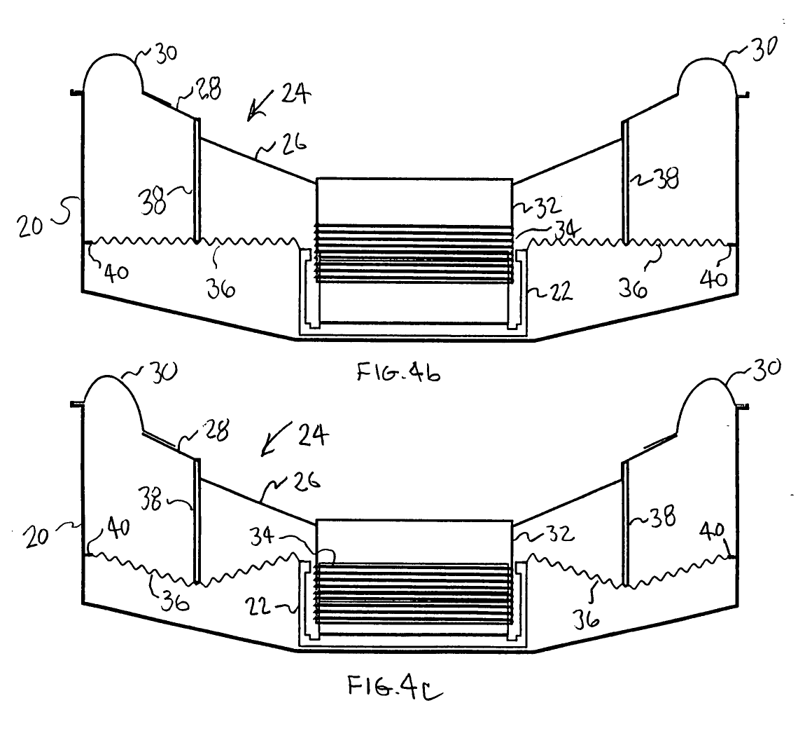

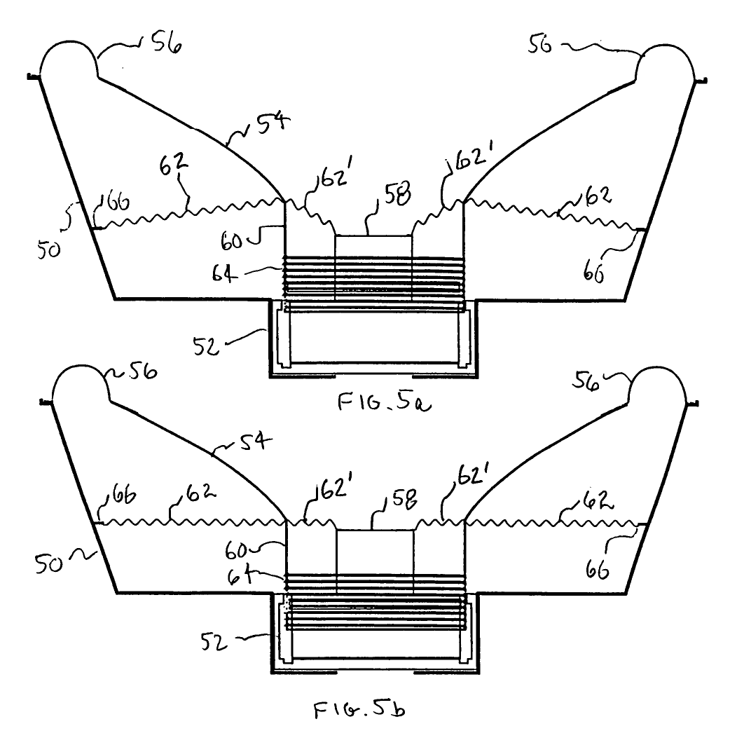

FIGS. 4a-4c illustrate the three positions discussed above of a speaker with a concave cone of a third embodiment of the present invention. This speaker includes a deep basket 20 with a magnet assembly 22 in the center bottom portion of the basket, a concave cone 24 affixed at the center to voice coil tube 32, with voice coil 34 on the lower end thereof. Tube 32 surrounds the central portion of magnet assembly 22. Cone 24 is shown here having a center conical section 26 with the outer rim affixed to downwardly extending ring 38 and an outer conical section 28 flaring out from the top of ring 38 (it should be noted that cone 24 could have a simple conical shape with ring 38 attached to the bottom of cone 24). The outer rim of cone section 28 is attached to the mouth of basket 20 via surround 30. Within the lower portion of basket 20 there is shown an attachment point 40 that encircles and extends a short distance into the inside of the basket. From FIG. 4b where the speaker is unenergized and cone 24 is in the static position, it can be seen that attachment point 40 is opposite the upper outer extent of magnet assembly 22 and the bottom edge of ring 38 which is approximately centered between attachment point 40 and the upper extent of magnet assembly 22. Additionally, there is a spider 36 (either a single piece or two pieces as discussed above) having the outer edge attached to attachment point 40 and the inner edge attached to the upper extent of magnet assembly 22. Approximately in the center of spider 36, the bottom edge of ring 38 is attached. From FIGS. 4a-4c it can be seen that forces on the end of ring 38 are balanced at each point of attachment to spider 36 as discussed previously for other embodiments of the present invention; not the opposite side of the speaker as in the prior art.

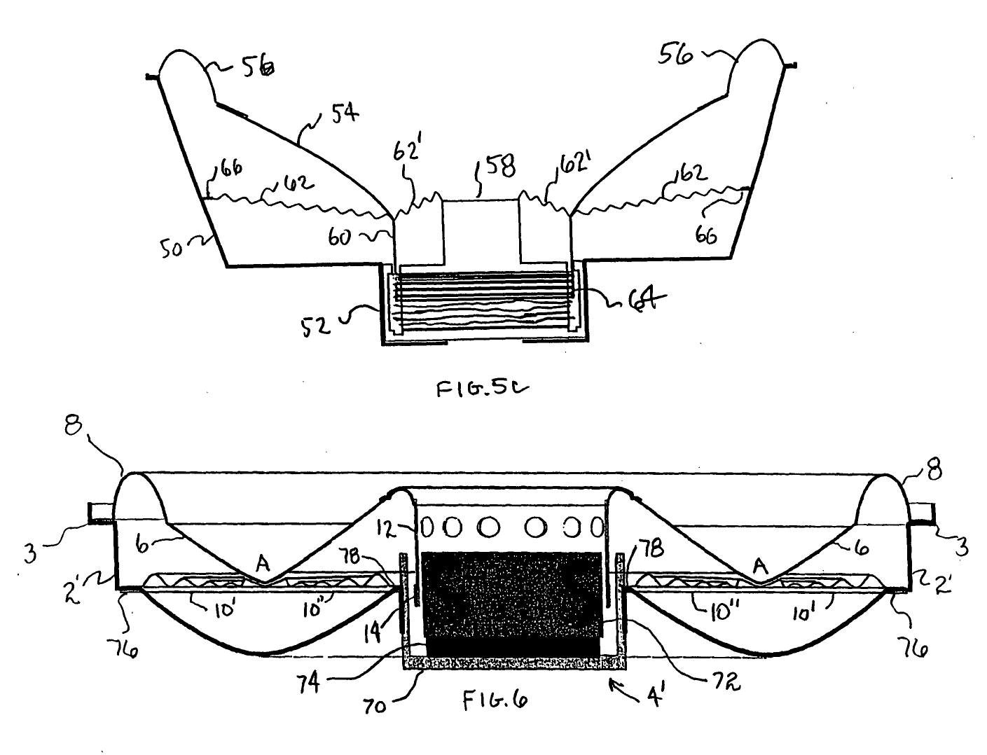

FIGS. 5a-5c are each a profile slice of the center of another design of a deep basket speaker. This speaker includes a deep basket 50 with a magnet assembly 52 in the center bottom portion of the basket, a concave cone 54 affixed at the center to voice coil tube 60, with voice coil 64 on the lower end thereof. Tube 60 surrounds magnet assembly 52 with the magnet assembly having an upper extending central pillar 58. The outer rim of cone 54 is connected to the mouth of basket 50 via surround 56, and the center of cone 54 is attached to the upper edge of voice coil tube 60. Within the lower portion of basket 50 there is shown an attachment point 66 that encircles and extends a short distance into the inside of the basket. From FIG. 5b where the speaker is unenergized and cone 54 is in the static position, it can be seen that attachment point 66 is opposite both the junction of cone 54 and voice coil tube 60 as well as the top of pillar 58 of magnet assembly 52. There is also a spider 62/62′ strung between attachment point 66 and the top of pillar 58 through the junction of cone 54 and tube 60. Spider 62/62′ can be either a single spider or two spiders as discussed above. From FIGS. 5a-5c it can be seen that forces on the junction of cone 54 and the top of tube 60 are balanced at each point of attachment to the spider by spider portions 62 and 62′ as discussed previously for other embodiments of the present invention; not the opposite side of the speaker as in the prior art. This embodiment is presented to illustrate that both portions of the spider of the present invention have to be beneath the cone of the speaker and all portions of the spider do not have to be outside the voice coil tube.

It is to be understood that in each of the embodiments illustrated in the figures and discussed herein the speaker has been shown in cross section as is typically done for ease of visualizing the speaker constructions. Additionally it is to be understood that spider, and spider portions, totally and continuously surround the central portion of the speaker or passive radiator.

From the variety of speaker configurations disclosed above that incorporate the balanced spider of the present invention, it is clear that the balanced spider can be incorporated into virtually all speaker designs. Thus, the present invention, simply stated, is the balancing of the forces at each point of attachment with the spider without one side being balanced from the opposite side of the speaker as in the prior art. Thus, the invention is not to be interpreted as being limited to only the speaker designs illustrated here, but to include any speaker design.

While the invention has been described with regard to several specific embodiments. Those skilled in the art will recognize that changes can be made in form and detail without departing from the spirit and scope of the invention. One skilled in the art will also find it obvious to extend the techniques discussed to a passive radiator, as well as any speaker or passive radiator configuration. This is true since a passive radiator is basically the same as a speaker without the electromagnetic engine for moving the diaphragm or baffle of the passive radiator.

What is claimed is:

1. A sound radiating device comprising:
a frame having an interior surface with a side portion extending upward from, and surrounding, said interior surface, said side portion terminating in an exterior edge a uniform height above said interior surface and having a predetermined size and shape with said side portion defining a first connection point spaced therearound that is inward and apart from said exterior edge;
a substantially stiff part having an outer edge, a top surface and a bottom surface with said outer edge being substantially the same shape as, and a smaller size than that defined by the exterior edge of the frame, with said bottom surface defining a second connection point therearound;
a flexible surround connected around and between the exterior edge of the frame and the outer edge of the substantially stiff part with the surround being less stiff than said stiff part;
a third connection point defined by said interior surface of said frame inward from said side portion and encircling a center of said frame with said third connection point in substantially a same horizontal plane with said first connection point;
a first resilient spider portion connected between said first and second connection points; and
a second resilient spider portion connected between said second and third connection points;
wherein said second connection point is substantially midway between said first and third connection points, and in substantially the same horizontal plane as said first and third connection points when said stiff part is in a static position as supported by said surround.

2. The sound radiating device of claim 1 wherein:
the first spider portion and the second spider portion each have concentric alternating ridges and valleys; and
both of the first spider portion and the second spider portion are connected to the second connection point in a valley of the spider portion.

3. The sound radiating device of claim 1 wherein:
the first spider portion is a first spider; and
the second spider portion is a second spider.

4. The sound radiating device is claim 1 wherein the first spider portion and the second spider portion are portions of a one piece spider.

5. The sound radiating device of claim 1 wherein a horizontal component of a first force exerted on the first spider portion in a first direction and a horizontal component of a second force exerted on the second spider portion in a second direction are in opposite directions and substantially equal to each other to cancel a horizontal force of the second connection point on the same side of the center of the frame between the first connection point and the second connection point at each radial around the frame.

6. The sound radiating device of claim 5 wherein the sum of the vertical components of the first force and second force is equal to, and in the opposite direction of, a vertical force exerted on the stiff part.

7. The sound radiating device of claim 1 further comprising:
a bobbin having a first end and a second end with the first end attached at the center of the bottom side of the flat center section of the stiff part;
a voice coil wound on the bobbin near the second end; and
a magnet assembly mounted centrally to the interior surface of the frame with the voice coil of the second end of the bobbin positioned to interact with the magnet assembly when an electrical signal is applied to the voice coil, wherein a top edge of the magnet assembly furthest from a center of the bobbin and the interior surface of the frame defines the third connection point.

8. The sound radiating device of claim 7 wherein a horizontal component of a first force exerted on the first spider portion in a first direction and a horizontal component of a second force exerted on the second spider portion in a second direction are in opposite directions and substantially equal to each other to cancel a horizontal force of the second connection point on the same side of the center of the frame between the first connection point and the second connection point at each radial around the frame.

9. The sound radiating device of claim 8 wherein the sum of the vertical components of the first force and second force is equal to, and in the opposite direction of, a vertical force exerted on the stiff part.

10. The sound radiating device of claim 1 wherein said stiff part has a substantially flat center section on both the top surface and the bottom surface with a “V” shaped groove opening to the top surface and surrounding said flat center section with the bottom point of said “V” shaped groove on the bottom surface defining the second connection point.

11. The sound radiating device of claim 1 wherein said stiff part is substantially flat on both the top surface and the bottom surface with a ring concentric with a center of the stiff part that extends downward from the bottom surface of the stiff part with the second connection point defined by an edge of the ring furthest from the bottom surface of the stiff part.

12. The sound radiating device of claim 11 further comprising:
a bobbin having a first end and a second end with the first end attached at the center of the bottom side of the stiff part;
a voice coil wound on the bobbin near the second end; and
a magnet assembly mounted centrally to the interior surface of the frame with the voice coil on the second end of the bobbin positioned to interact with the magnet assembly when an electrical signal is applied to the voice coil, wherein a top edge of the magnet assembly furthest from a center of the bobbin and the interior surface of the frame defines the third connection point.

13. The sound radiating device of claim 1 wherein the stiff part includes a concave cone with a ring concentric with a center of the cone that extends downward from the bottom surface of the cone to a point below a deepest point of the cone and with the second connection point defined by an edge of the ring furthest from the bottom surface of the cone.

14. The sound radiating device of claim 13 further comprising:
a bobbin having a first end and a second end with the first end attached at the center of the bottom side of the cone;
a voice coil wound on the bobbin near the second end; and
a magnet assembly mounted centrally to the interior surface of the frame with the voice coil on the second end of the bobbin positioned to interact with the magnet assembly when an electrical signal is applied to the voice coil, wherein a top edge of the magnet assembly furthest from a center of the bobbin and the interior surface of the frame below the deepest point of the cone defines the third connection point.

15. The sound radiating device of claim 13 wherein the cone includes an outer cone section between the surround and the ring, and an inner cone section extending toward the center of the basket from the ring.

16. The sound radiating device of claim 1 wherein the stiff part includes a concave cone with open center hole therethrough with the second connection point defined by an edge of the open center hole of the cone.

17. The sound radiating device of claim 16 further comprising:
a bobbin having a first end and a second end with the first end attached the edge of the open center hole of the cone;
a voice coil wound on the bobbin near the second end; and
a magnet assembly mounted centrally to the interior surface of the frame with to the voice coil on the second end of the bobbin positioned to interact with the magnet assembly when an electrical signal is applied to the voice coil, wherein a top edge of the magnet assembly interior to a center of the bobbin and the interior surface of the frame defines the third connection point.

18. A method of minimizing flexure of a stiff part of a radiating device during operation, the radiating device including a frame having an interior surface with a side portion extending upward from, and surrounding, said interior surface, said side portion terminating in an exterior edge a uniform height above said interior surface and having a predetermined size and shape, the stiff part having an outer edge, a top surface and a bottom surface with said outer edge being substantially the same shape as, and a smaller size than that defined by the exterior edge of the frame, and a flexible surround connected around and between the exterior edge of the frame and the outer edge of the stiff part, the method comprising:
a. providing a first connection point within the frame on, and around, the side portion spaced apart a uniform distance from the exterior edge of the frame;
b. providing a second connection point on, and around, the bottom surface of the stiff part concentric with a center of the stiff part;
c. providing a third connection point affixed to the interior surface of the frame inward from the side portion and encircling a center of the frame with the third connection point in substantially a same horizontal plane with the first connection point;
d. connecting a first resilient spider portion between the first and second connection points; and
e. connecting a second resilient spider portion between said second and third connection points;
wherein the second connection point is substantially midway between the first and third connection points, and in substantially the same horizontal plane as the first and third connection points when the stiff part is in a static position as supported by the surround.

19. the method of claim 18 wherein a horizontal component of a first force exerted on the first spider portion in a first direction and a horizontal component of a second force exerted on the second spider portion in a second direction are in opposite directions and substantially equal to each other to cancel a horizontal force of the second connection point on the same side of the center of the frame between the first connection point and the second connection point radially around the frame to minimize flexure of the stiff part in all positions vertically.

20. The method of claim 19 wherein the sum of the vertical components of the first force and second force is equal to, and in the opposite direction of, a vertical force exerted on the stiff part in all positions vertically.

21. A method of minimizing flexure of a stiff part of a radiating device during operation, the radiating device including a frame having an interior surface with a side portion extending upward from, and surrounding, said interior surface, said side portion terminating in an exterior edge a uniform height above said interior surface and having a predetermined size and shape, the stiff part having an outer edge, a top surface and a bottom surface with said outer edge being substantially the same shape as, and a smaller size than that defined by the exterior edge of the frame, a flexible surround connected around and between the exterior edge of the frame and the outer edge of the stiff part, a bobbin having a first end and a second end with the first end attached at the center of the bottom side of stiff part, a voice coil wound on the bobbin near the second end, and a magnet assembly mounted centrally to the interior surface of the frame with the voice coil of the second end of the bobbin positioned to interact with the magnet assembly when an electrical signal is applied to the voice coil, the method comprising:
a. providing a first connection point within the frame on, and around, the side portion spaced apart a uniform distance from the exterior edge of the frame;
b. providing a second connection point on, and around, a top edge of the magnet assembly furthest from a center of the bobbin and the interior surface of the frame;
c. providing a third connection point affixed to the interior surface of the frame inward from the side portion and encircling a center of the frame with the third connection point in substantially a same horizontal plane with the first connection point;
d. connecting a first resilient spider portion between the first and second connection points; and
e. connecting a second resilient spider portion between said second and third connection points;
wherein the second connection point is substantially midway between the first and third connection points, and in substantially the same horizontal plane as the first and third connection points when the stiff part is in a static position as supported by the surround.

22. the method of claim 21 wherein a horizontal component of a first force exerted on the first spider portion in a first direction and a horizontal component of a second force exerted on the second spider portion in a second direction are in opposite directions and substantially equal to each other to cancel a horizontal force of the second connection point on the same side of the center of the frame between the first connection point and the second connection point radially around the frame to minimize flexure of the stiff part in all positions vertically.

23. The method of claim 22 wherein the sum of the vertical components of the first force and second force is equal to, and in the opposite direction of, a vertical force exerted on the stiff part in all positions vertically.
